(19) United States
(12) Patent Application Publication
(10) Pub. No.: US 2017/0212587 A1
(43) Pub. Date: Jul. 27, 2017

(54) ELECTRONIC DEVICE

(71) Applicant: KYOCERA Corporation, Kyoto-shi, Kyoto (JP)

(72) Inventor: Akiyoshi NODA, Meguro-ku, Tokyo (JP)

(21) Appl. No.: 15/515,136

(22) PCT Filed: Sep. 29, 2015
(86) PCT No.: PCT/JP2015/077525

§ 371 Date: Mar. 28, 2017

(30) Foreign Application Priority Data
Sep. 29, 2014 (JP) 2014-199004

(51) Int. Cl. G06F 3/01; G02B 27/01

(52) U.S. Cl. CPC G06F 3/013; G02B 27/0172; G02B 2027/0178; G02B 2027/0141; G02B 2027/014

(57) ABSTRACT

An electronic device includes a display and a detector that detects a user's gaze movement. When the detector detects that the gaze moves in a predetermined direction, the electronic device displays a first image in the predetermined direction side in a display area of the display. By having such a configuration, it is possible to provide the electronic device provided with a new input mode for further improving the operability upon input. For example, the first image may be displayed near a point where an outer part of the display area and a gaze movement direction intersect in the display area of the display.

### RELATED APPLICATIONS

The present application is a National Phase of International Application Number PCT/JP2015/077525, filed Sep. 29, 2015, which claims priority to Japanese Application Number 2014-199004, filed Sep. 29, 2014.

### FIELD

The present invention relates to an electronic device capable of performing a predetermined input according to a physical movement of a user.

### BACKGROUND

Recently, as the electronic device, there is a head mounted display that detects a user's gaze direction from an eye potential caused by eye movement and performs display control of a display according to the gaze direction.

Moreover, as the electronic device, there is a gesture recognition device that recognizes a gesture of a user from a moving image captured by the user to determine a type of the gesture and controls a control target based on the determined type of the gesture.

An electronic device according to the present invention includes a display, and a detector configured to detect a user's gaze movement. When the detector detects that the user's gaze moves in a predetermined direction, a first image is configured to be displayed in the predetermined direction side in a display area of the display.

### BRIEF DESCRIPTION OF DRAWINGS

FIG. 1 is a diagram illustrating a schematic configuration of an electronic device 1 according to the present invention.

FIG. 2 is a diagram illustrating a rear side of the electronic device 1 according to the present invention.

FIG. 3 is a diagram illustrating a rear side of another electronic device 1 according to the present invention.

FIG. 4 is a diagram illustrating a functional block of the electronic device 1 according to some embodiments of the present invention.

FIG. 5 is a diagram illustrating an example of a combination of a predetermined user's eye movement and an output pattern associated with the eye movement.

FIG. 6 is a diagram illustrating a first example of a display mode of a display 20 in the electronic device 1.

FIG. 7 is a diagram illustrating a second example of the display mode of the display 20 in the electronic device 1.

FIG. 8 is a diagram illustrating a third example of the display mode of the display 20 in the electronic device 1.

FIG. 9 is a diagram illustrating a fourth example of the display mode of the display 20 in the electronic device 1.

FIG. 10 is a diagram illustrating a fifth example of the display mode of the display 20 in the electronic device 1.

FIG. 11 is a diagram illustrating a sixth example of the display mode of the display 20 in the electronic device 1.

FIG. 12 is a diagram illustrating a seventh example of the display mode of the display 20 in the electronic device 1.

FIG. 13A is a diagram illustrating another form of the electronic device 1.

FIG. 13B is a diagram illustrating still another form of the electronic device 1.

### DESCRIPTION OF EMBODIMENTS

Exemplary embodiments of the present invention will be explained in detail below with reference to the accompanying drawings. It should be noted that the present invention is not limited by the following explanation. In addition, the components in the explanation below include those which are easily thought of by persons skilled in the art, those which are substantially equivalents, and those in a scope of so-called equivalents. In the head mounted display and the recognition device, it is desired to propose a new input mode for further improving the operability upon input. It is an object of the present invention to provide an electronic device provided with a new input mode for further improving the operability upon input. According to the present invention, it is possible to provide an electronic device provided with a new input mode for further improving the operability upon input.

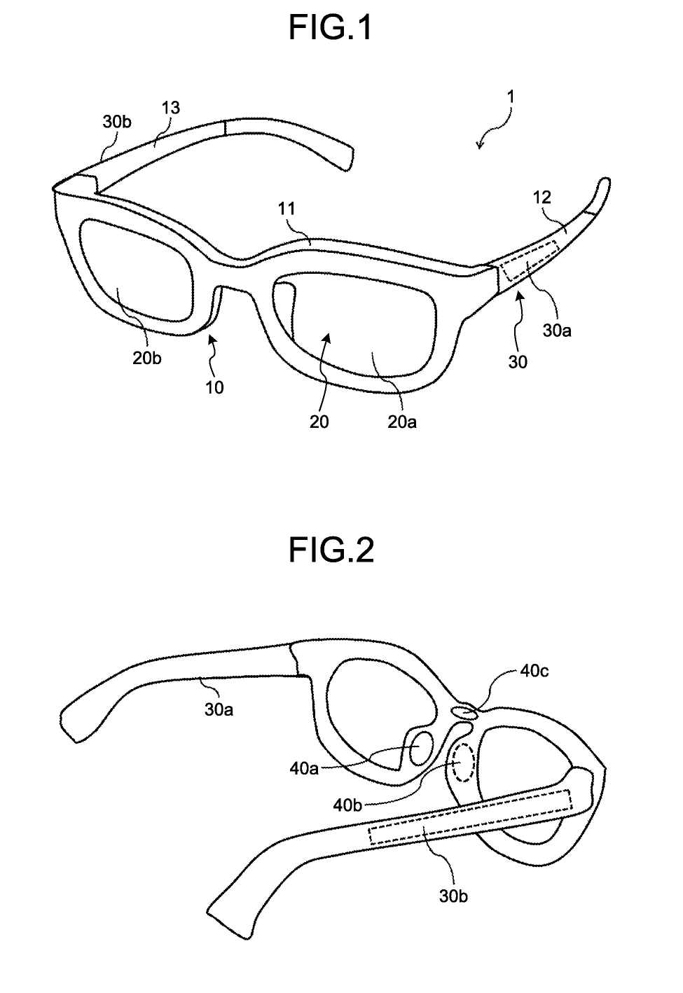

FIG. 1 is a diagram illustrating a schematic configuration of the electronic device 1 according to some embodiments of the present invention. The electronic device 1 illustrated in FIG. 1 includes a wearing portion 10 that is wearable on the head of a user, a display 20 mounted on the wearing portion 10 and provided in front of user's eyes, and an operation part 30 mounted in part of the wearing portion 10. The display 20 displays an image in part or whole area of the display 20 so that the user can visually recognize the image.

As illustrated in FIG. 1, the electronic device 1 is in the form of eyeglasses (form of goggles). The wearing portion 10 of the electronic device 1 includes a front part 11 and side parts 12 and 13. When the wearing portion 10 is worn on the user's head, the front part 11 is arranged in front of the user's eyes, and the side parts 12 and 13 are arranged along side portions of the user's head.

As explained above, the front part 11 is a portion arranged in front of the user's eyes when worn on the user's head. The front part 11 is configured so that a bridge is integrated with two marginal parts (rims) provided in right and left sides across the bridge. The bridge is a portion contacting a user's nose upon wearing the electronic device 1, and is in the form of a recess along the user's nose. The marginal parts support the display 20. The marginal parts are connected to the side parts 12 and 13.

As explained above, when worn on the user's head, the side parts 12 and 13 are portions (temple parts of the eyeglasses) arranged along the both side portions of the user's head, and one edge of each of the side parts is connected to one edge of the front part 11. A spring for pressure adjustment and an adjuster for changing an angle are arranged at the end portion (hinge portion of the temple of the eyeglasses) of the side part 12 connected to the front part 11 in order to match user's feeling.

The display 20 includes a pair of display parts (a first display part 20a and a second display part 20b) provided in front of the user's right and left eyes. The first display part 20a and the second display part 20b of the display 20 are surrounded with the marginal parts of the front part 11.

The display 20 can use a display panel such as an LCD (Liquid Crystal Display) and an OELD (Organic Electro-Luminescence Display) panels. For the display 20, the display panel is preferably made of a translucent or transparent plate-like member. By making the display panel of the display 20 with the translucent or transparent plate-like member, it is possible for the user to see the view through the display 20.

The operation part 30 has touch sensors 30a and 30b which are provided in the side parts 12 and 13 respectively and detect respective contacts. Various types of sensors such as a capacitive type sensor, an ultrasonic type sensor, a pressure sensitive type sensor, a resistive film type sensor, and an optical detection type sensor can be used for the touch sensors 30a and 30b. In the electronic device 1 according to the present invention, the operation part 30 may be configured to have only either one of the touch sensors 30a and 30b.

FIG. 2 is a diagram illustrating a rear side of the electronic device 1 according to the present invention. The electronic device 1 includes a myoelectric sensor 40 as a detector 40 which is explained later.

The myoelectric sensor 40 has electrodes at locations contactable with areas around the user's eyes and detects myoelectric potentials produced in accordance with user's eye movements (blink or gaze movement). As a measuring electrode to measure a myoelectric potential, a first electrode 40a and a second electrode 40b respectively contactable with the right and left sides of the user's nose are provided at nose pads extending from the bridge of the wearing portion 10. As a reference electrode, a third electrode 40c contactable with the center of the user's nose is provided on the bridge. By having such a configuration, the myoelectric sensor 40 detects changes in potentials of the first electrode 40a and of the second electrode 40b based on the third electrode 40c, for example, when the user moves the eyes in a predetermined direction (or when he/she is blinking).

The third electrode 40c as the reference electrode used for the myoelectric sensor 40 may be provided at a location different from the bridge. For example, the third electrode 40c may be provided near an end portion opposite to the front part 11 on the side part 12 (or the side part 13).

Although FIG. 2 represents the configuration in which the electronic device 1 includes the myoelectric sensor 40 as the detector 40, the detector 40 is not limited to the myoelectric sensor.

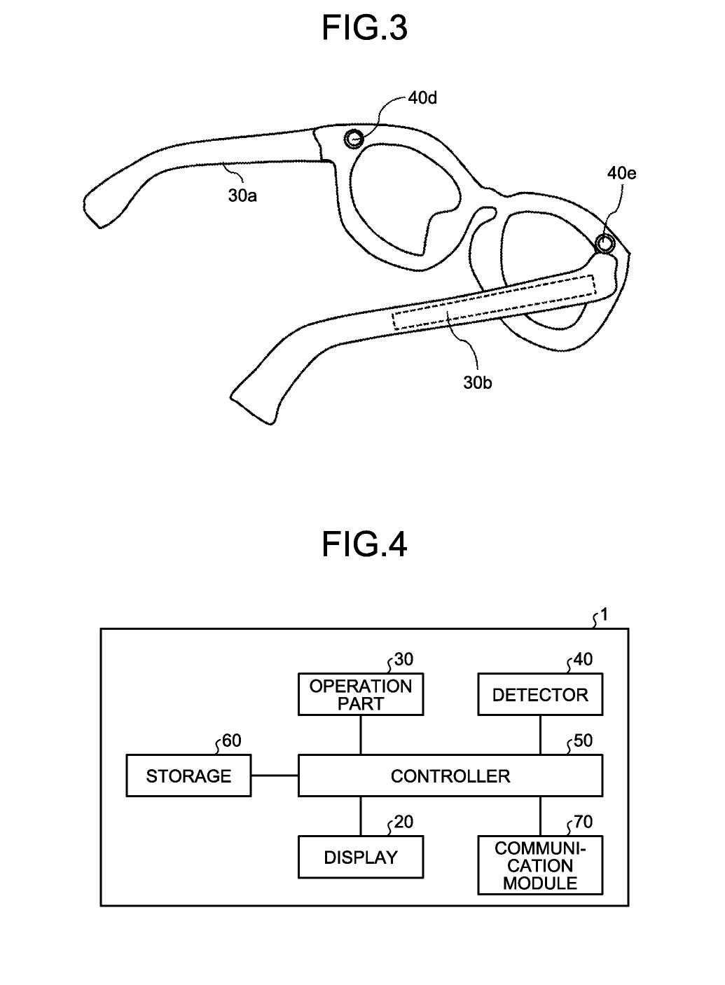

FIG. 3 is a diagram illustrating a rear side of the electronic device 1 according to another embodiment of the present invention. The electronic device 1 includes an imaging module 40 as the detector 40.

The imaging module 40 is provided so as to face a user's face in the front part 11 of the electronic device 1. The imaging module 40 is respectively provided near the right and left end portions (respectively called 40d and 40e) of the front part 11. The imaging module 40 includes a lens system including an imaging lens, a diaphragm, a zoom lens, a focus lens, and the like; a drive system causing a focus operation and a zoom operation to be performed with respect to the lens system; and a solid-state imaging element array that photoelectrically converts an imaging light obtained by the lens system to generate an imaging signal. The solid-state imaging element array may be implemented by, for example, a CCD (Charge Coupled Device) sensor array and a CMOS (Complementary Metal Oxide Semiconductor) sensor array.

Functions of the electronic device 1 according to the present invention will be explained next with reference to FIG. 4. FIG. 4 is a diagram illustrating a functional block of the electronic device 1 according to some embodiments of the present invention. As illustrated in FIG. 4, the electronic device 1 according to the present invention includes the display 20, the operation part 30, the detector 40, a controller 50, a storage 60, and a communication module 70.

The display 20 displays videos and images based on control by the controller 50. It suffices that the display 20 can display an image that the user can visually recognize, that is, it is sufficient that the display 20 can show an image to the user, and various configurations can be used. For example, the display 20 may be configured to project an image to a display panel (screen) like a projector. When an image is to be projected, it may be configured to scan a laser light to project an image, or it may be configured to transmit light through a liquid crystal panel to project an image. Moreover, it may be configured to display an image to the user by irradiating a laser light directly from the display 20 toward the user.

As explained above, the operation part 30 is a touch sensor provided on, for example, the side parts 12 and 13 of the electronic device 1, and detects a position where a user's finger touches each of the side parts 12 and 13 as an input position. The operation part 30 outputs a signal according to the detected input position to the controller 50. Thus, the user can perform various touch operations for the electronic device 1. As a type of the touch operation, for example, there is an operation of releasing a finger within a short period of time after the finger is brought into contact with each of the side parts 12 and 13. There is also an operation of flicking fingers at each of the side parts 12 and 13 in an arbitrary direction (e.g., a longitudinal direction of the side part). Moreover, there is an operation (slide operation) of moving fingers in the longitudinal direction of the side part while keeping the fingers in contact with each of the side parts 12 and 13. The direction of moving the finger is not limited thereto, and therefore it may be an operation of moving the finger in a lateral direction of the side part. Moreover, for a predetermined face of the side part, movements of fingers in the longitudinal direction and the lateral direction (i.e. X-axis direction and Y-axis direction) of the face may be simultaneously detected.

The operation part 30 is not limited to the touch sensor, and may be, for example, one or more buttons.

When the detector 40 is the myoelectric sensor 40, as explanation above, the detector 40 detects a change in myoelectric potential when the user moves the eyes in a predetermined direction (or when he/she is blinking). The myoelectric sensor 40 outputs information of the detected change in the myoelectric potential to the controller 50.

On the other hand, when the detector 40 is the imaging module 40, the imaging module 40 captures images of the user's eyes. The imaging module 40 outputs image data acquired through capturing or a series of image data acquired through capturing at each predetermined time (e.g., 1/15 sec.) to the controller 50 as moving-image data.

The controller 50 includes, for example, an MPU (Micro Processing Unit), and executes various processings of the electronic device 1 according to the procedure instructed by software. In other words, the controller 50 executes processing by sequentially reading instruction codes from an operating system program, a program of an application, or the like. Thus, the controller 50 controls the operations of the modules, and outputs a control signal (or an image signal) for displaying data required for the modules such as a video and an image on the display 20.

The controller 50 estimates user's eye movement based on the information of the change in the myoelectric potential output from the myoelectric sensor 40 as the detector 40. The eye movement corresponds to the presence or absence of blink or the presence or absence of gaze movement (which includes changes of a gaze direction and a gaze position, or the like).

Alternatively, the controller 50 extracts a subject (eye) included in the image data or in the moving-image data output from the imaging module 40 as the detector 40 and analyzes the movement of the subject (eye), and thereby estimates a user's eye movement. The eye movement corresponds to the presence or absence of blink or the presence or absence of gaze movement (which includes changes of a gaze direction and a gaze position, or the like). For example, the controller 50 extracts a subject (eye) included in the image data or in the moving-image data and further performs predetermined processing such as calculation of the center of a black-eye area on the extracted subject, and thereby estimates the presence or absence of the gaze movement. As the method of extracting a subject from an image, various image processing technologies can be used.

The storage 60 includes, for example, nonvolatile storage devices (nonvolatile semiconductor memory such as ROM: Read Only Memory, a hard disk drive etc.) and a readable/writable storage device (e.g., SRAM: Static Random Access Memory, and DRAM: Dynamic Random Access Memory), and stores various programs. The storage 60 previously stores user's eye movement patterns which can be estimated from the information output from the detector 40 and a plurality of output patterns associated with the eye movement patterns respectively.

The communication module 70 includes an antenna and an RF circuit module and performs wireless or wired communications (telephone communication and information communication) with an external device based on the control by the controller 50.

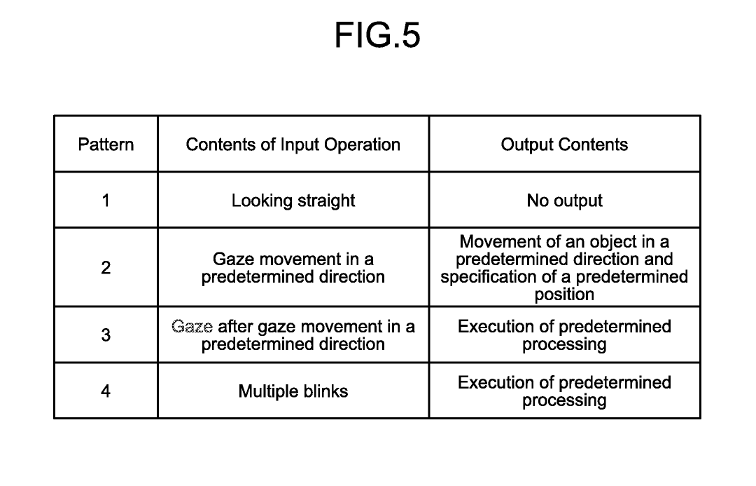

An example in which the electronic device 1 detects a predetermined user's eye movement and thereby performs a predetermined output operation associated with the movement will be explained below with reference to FIG. 5 to FIG. 12. FIG. 5 represents an example of a combination of a predetermined user's eye movement and an output pattern associated with the eye movement, which are stored in the storage 60.

In Pattern 1, the user is in a state of “looking straight” and does not perform a predetermined eye movement. In this case, the controller 50 does not recognize an input operation performed by the user and therefore does not perform output processing.

“Gaze movement in a predetermined direction” in Pattern 2 is associated with, for example, a movement of an object in a predetermined direction on a display screen. Moreover, “Gaze movement in a predetermined direction” may be associated with, for example, an operation of specifying a predetermined position on a display flat screen. “Gaze movement in a predetermined direction” may cause, for example, the electronic device 1 to execute predetermined processing. The predetermined processing includes, for example, processing for displaying a predetermined operation screen on the display 20.

An action of “gaze after gaze movement in a predetermined direction” in Pattern 3 is associated with, for example, an operation for causing the electronic device 1 to execute predetermined processing. For example, when the user's gaze position is moved to a position that is superimposed on a predetermined operation icon displayed on the display 20 and thereafter the user gazes at the operation icon for a predetermined time (e.g., 1 sec.) or more, it is regarded that the operation icon is selected, and the predetermined processing associated with the operation icon is executed.

An action of “multiple blinks” in Pattern 4 is associated with, for example, an operation for causing the electronic device 1 to execute predetermined processing. For example, when the user blinks a few times in a state in which the user's gaze position is superimposed on a predetermined operation icon displayed on the display 20, it is regarded that the operation icon is selected, and the predetermined processing associated with the operation icon is executed. In addition, the blinks may be assigned to an input for implementing an I/O operation such as activation or stop of the electronic device 1, shift to a sleep state or its cancel, and execution or stop of music reproduction in a music application.

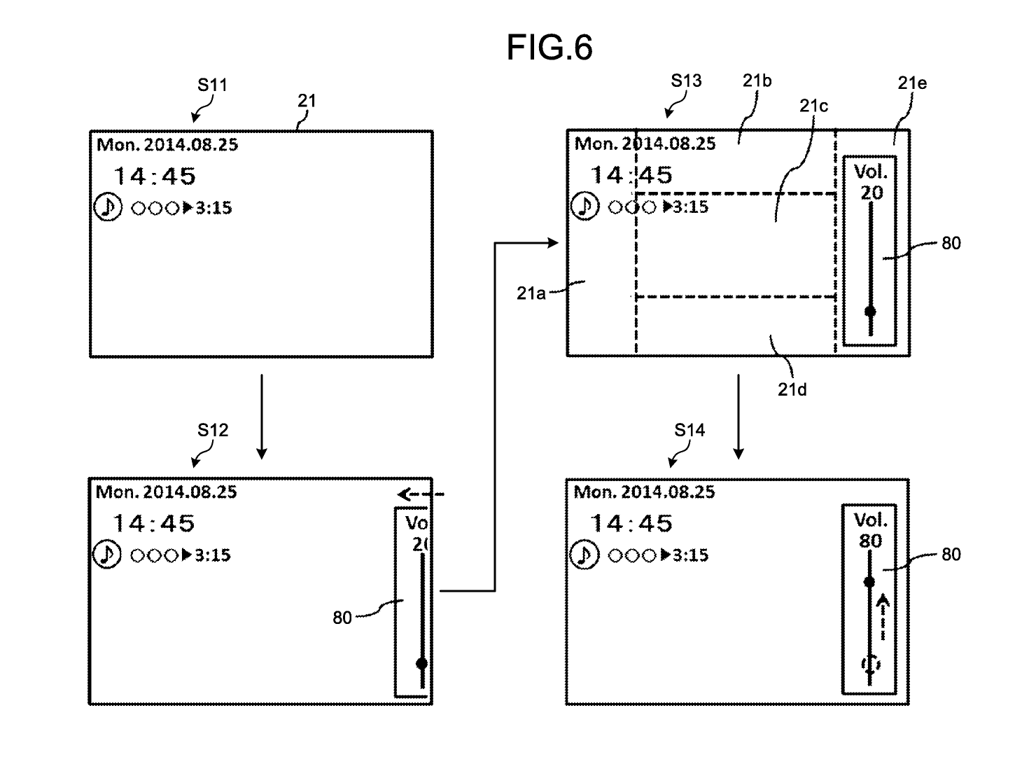

A display mode of the display 20 in the electronic device 1 will be explained next. FIG. 6 is a diagram illustrating a first example of the display mode of the display 20 in the electronic device 1. The shape of the display 20 may include a curved portion such as the electronic device 1 illustrated in FIG. 1. However, for the sake of simplicity, FIG. 6 represents a rectangular area as a display area 21 obtained by partially extracting an area of the display 20.

As illustrated at Step S11 of FIG. 6, the electronic device 1 displays date/time and information (music name, reproduction time, etc.) for the music being reproduced related to a music application being executed by the electronic device 1 in the upper left side of the display area 21. The information is displayed as character information, however, it is not limited to the display mode. For example, it may be displayed in such a manner that opaque characters are superimposed on a colored transparent image, or it may be displayed in such a manner that characters are superimposed on an opaque image. The display mode illustrated at Step S11 is taken, for example, when the user is in the state of “looking straight” (Pattern 1 in FIG. 5).

When the detector 40 detects that the user's gaze moves to the right, the electronic device 1 displays an object 80 for volume adjustment during the music reproduction in the display area 21 of the display 20 as illustrated at Step S12 and Step S13 of FIG. 6. The object 80 includes a slide bar for adjusting the volume.

Step S12 of FIG. 6 represents an intermediate process of displaying the object 80. Step S13 of FIG. 6 represents a state after the object 80 is displayed on the display 20. As understood from Step S12, when the user moves his/her gaze to the right, the object 80 appears in the display area 21 so as to enter the inside from the outside of the right end portion of the display area 21. At Step S13, a diagram in which the display area 21 is divided into five areas (21a to 21e) is schematically displayed, and a display position of the object 80 when the user moves the gaze to the right is the area 21e which is the right end portion of the display area 21.

As illustrated at Step S11 to Step S13 of FIG. 6, the electronic device 1 according to the present invention has a configuration in which a predetermined first image (object) is displayed in the display 20 when the detector 40 detects that the user's gaze moves in a predetermined direction. Therefore, the electronic device 1 does not display the image when the user does not move the gaze, so that a user's view is kept wider, and can display a user's desired image when the user intentionally moves the gaze, thus improving the convenience. In other words, the electronic device 1 is capable of implementing an input mode with improved operability upon input.

Here, when a path of user's gaze in a series of gaze movements of the user is not linear but includes many curved portions, a user's gaze movement direction is difficult to be specified. In this case, the electronic device 1 may specify, for example, a line connecting a point (start point) where the gaze movement is started and a point (end point) where the gaze movement is ended, as the direction of the user's gaze movement. Moreover, the electronic device 1 may specify, for example, a line connecting a point (end point) where the gaze movement is ended and a point where the gaze movement is back to predetermined blocks from the end point, as the direction of the user's gaze movement.

In the electronic device 1 according to the present invention, the predetermined first image may be displayed near a point where an outer part of the display area 21 and the user's gaze direction intersect. For example, as illustrated at Step S12 and Step S13 of FIG. 6, when the user's gaze moves to the right and the movement direction intersects with the right side of the display area 21, the electronic device 1 displays the object 80 (first image) in the area (area 21e) near the right side thereof.

In the electronic device 1 according to the present invention, the predetermined first image (object 80) is displayed in such a manner that the first image enters the inside from the outside in the display area 21 of the display 20. By configuring the electronic device 1 in this manner, it becomes easier for the user to recognize that a desired image (object 80) is displayed, which is triggered by the user's gaze movement.

In the above explanation, the electronic device 1 displays the object 80 triggered simply by the user's gaze movement to the right, however, the embodiments are not limited thereto. For example, the object 80 may be displayed when the user's gaze position moves to the area 21e at Step S13 of FIG. 6. In other words, the electronic device 1 according to the present invention may have a configuration in which, when the gaze is moved from a first area to a second area of the areas obtained by being previously divided in the display area 21 of the display 20, a predetermined first image is displayed in the second area. By having such a configuration, the electronic device 1 can display a user's desired image at a position to which the user actually moves his/her eyes, thus it becomes easier for the user to recognize the image.

At this time, the first image (object 80) may be displayed in such a manner that the image enters inside of the second area from an area opposite to the first area in the outside of the second area.

Moreover, the electronic device 1 may display the object 80 in the area 21e, which is triggered when the user's gaze position continuously stays in the area 21e at Step S13 of FIG. 6 for a predetermined time or more. In other words, the electronic device 1 according to the present invention may have a configuration in which, when the detector 40 detects that the gaze position continuously stays in a predetermined display area of the display 20, a predetermined first image is displayed in the display area.

The electronic device 1 may display the first image at predetermined timing, which is triggered when the user's gaze position is in a predetermined display area of the display 20. For example, when the user's gaze position is in the area 21e as the predetermined display area of the display 20 upon starting up the electronic device 1 according to the present invention, the electronic device 1 may display the object 80 as the first image.

The electronic device 1 may set the first area as a main display area in which a predetermined display always appears and may set the second area as a sub-display area in which display is performed only when the user's gaze position is superimposed on the second area.

When the electronic device 1 is configured to display an operation icon, as the predetermined first image, for executing predetermined processing in a predetermined application during execution, the electronic device 1 can be easily operated by the user performing a predetermined operation on the operation icon.

By referring again to FIG. 6, at Step S13 of FIG. 6, the electronic device 1 displays the object 80 (slide bar) for volume adjustment in the area 21e and a state in which the volume is currently set to 20 and the music is being reproduced. In this state, the electronic device 1 can adjust the volume by a user's further operation. For example, by performing a predetermined operation for the operation part 30, it is possible to adjust the volume. As explained above, when the user performs a slide operation on the side part 12 or 13 of the electronic device 1 as the predetermined operation for the operation part 30, the electronic device 1 adjusts the volume, which is triggered when the touch sensor as the operation part 30 detects this operation. For example, as illustrated at Step S13 of FIG. 6, in a state where the volume is 20, when the user touches the side part 12 of the electronic device 1 to perform the slide operation from the rear to the front, the volume of the electronic device 1 increases to 80 as illustrated at Step S14 of FIG. 6.

In other words, the electronic device 1 according to the present invention has a configuration in which a parameter is adjusted by displaying the first image including the object 80 (slide bar) capable of adjusting the parameter associated with execution contents of the application, which is triggered by the gaze movement, and by performing the predetermined operation using the operation part 30 in a state of displaying the first image. By having such a configuration, the electronic device 1 can perform more types of operations by combining a content detected by the detector 40 with a content operated for the operation part 30.

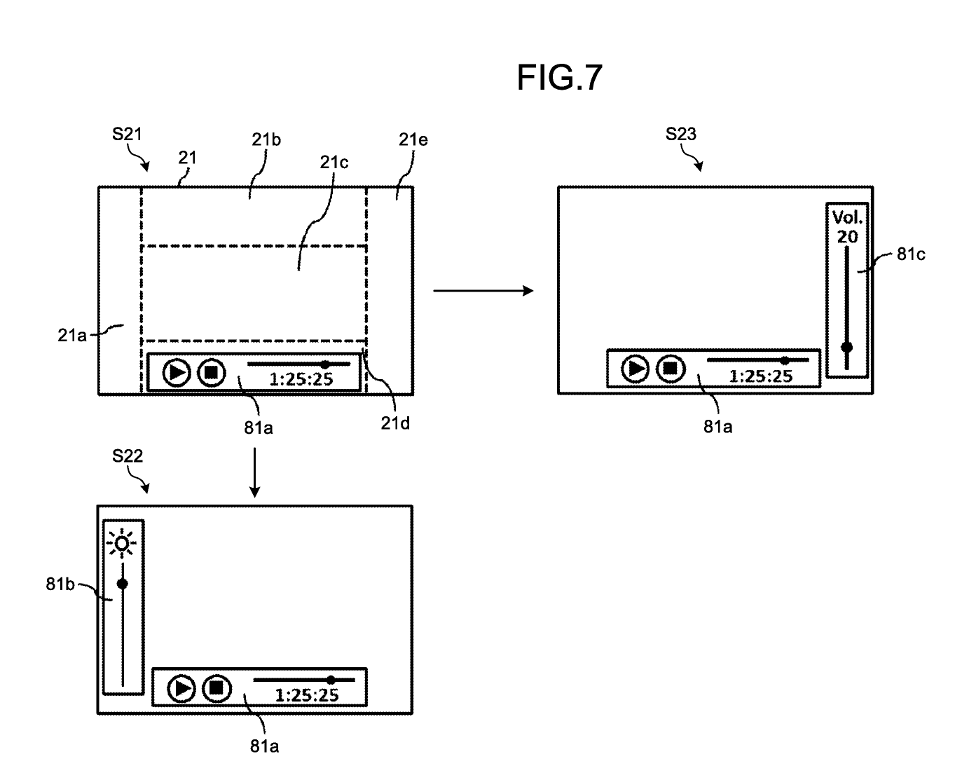

Another display mode of the display 20 in the electronic device 1 will be explained next. FIG. 7 is a diagram illustrating a second example of the display mode of the display 20 in the electronic device 1. FIG. 7 represents an example of how the electronic device 1 performs moving-image reproduction.

As schematically illustrated at Step S21 of FIG. 7, the display area 21 is previously divided into five areas (21a to 21e). As illustrated at Step S21 of FIG. 7, the electronic device 1 displays an object 81a including operation icons related to a moving-image reproduction application (moving-image reproduction icon, reproduction/stop icon, and seek bar (function to display a reproduction portion of data), etc.) in the area 21d.

When the detector 40 detects that the user's gaze moves to the left in a state illustrated at Step S21 of FIG. 7, the electronic device 1 displays, as illustrated at Step S22 of FIG. 7, an object 81b for adjusting brightness in a left area of the display 20 (which corresponds to the area 21a at Step S21 of FIG. 7).

When the detector 40 detects that the user's gaze moves to the right in the state illustrated at Step S21 of FIG. 7, the electronic device 1 displays, as illustrated at Step S23 of FIG. 7, an object 81c for adjusting volume in a right area of the display 20 (which corresponds to the area 21e at Step S21 of FIG. 7).

As explained above, when the user's gaze moves to the left, the electronic device 1 according to the present invention displays the first image in the area 21a on the left side within the divided areas in the display area 21 of the display 20, and displays, when the user's gaze moves to the right, the second image in the area 21e on the right side within the divided areas in the display area 21 of the display 20. By having such a configuration, the electronic device 1 can display different images depending on gaze movement directions and can also display the images near the position to which the gaze moves, thus improving the convenience.

In the explanation, the electronic device 1 displays an object, which is triggered when the user's gaze simply moves in a predetermined direction, however, the embodiments are not limited thereto. For example, when the gaze moves from the first area (area 21c) to the second area (area 21a) within the previously divided areas in the display area 21 of the display 20, the electronic device 1 may display the object 81b (first image) in the second area, and may display, when the gaze moves from the first area (area 21c) to a third area (area 21e), the object 81c (second image) in the third area.

For example, the electronic device 1 may display the object 81b (first image) in the area 21a, which is triggered when the user's gaze position continuously stays in the area 21a at Step S21 of FIG. 7 for a predetermined time or more, and may display the object 81c (second image) in the area 21e, which is triggered when the gaze position continuously stays in the area 21e at Step S21 of FIG. 7 for a predetermined time.

In the example illustrated in FIG. 7, the electronic device 1 has the configuration in which the object 81b as the first image is displayed in the area (area 21a) on the left side of the display 20 and the object 81c as the second image is displayed in the area (area 21e) on the right side of the display 20, however, the configuration is not limited thereto. For example, the electronic device 1 may display the first image (object 81b) in the area (area 21a) on the left side of the display 20 and may also display the first image (object 81b) in the area (area 21e) on the right side of the display 20. The electronic device 1 may have a configuration in which the same objects are displayed in both the area 21a and the area 21e.

The electronic device 1 is not limited to the configuration in which the objects are displayed in areas (the area 21a and the area 21e) near the left and right end portions of the display 20. For example, when the user's gaze moves downward, the electronic device 1 may display the object in the area 21d on the lower end portion of the display 20, and may display, when the user's gaze moves upward, the object in the area 21b on the upper end portion of the display 20. In other words, the electronic device 1 according to the present invention may display a third image when the user's gaze moves in a third direction, and may display a fourth image when the user's gaze moves in a fourth direction. The third image herein is, for example, the object 81a illustrated in FIG. 7 (in this case, the object 81a is not always displayed). The fourth image may be, for example, information such as date and time as illustrated in FIG. 6.

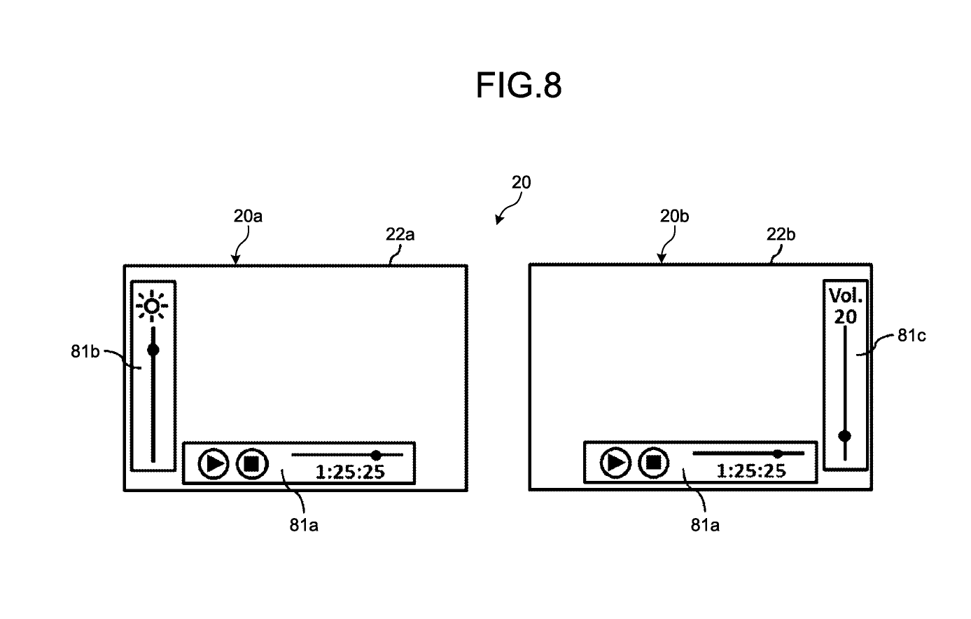

FIG. 8 is a diagram illustrating a third example of the display mode of the display 20 in the electronic device 1. FIG. 8 represents an example, similar to the second example, in which the electronic device 1 performs moving-image reproduction. As illustrated in FIG. 8, the display 20 includes the first display part 20a provided in front of the user's left eye and the second display part 20b provided in front of the user's right eye as illustrated in FIG. 1. Herein, when the user's gaze moves to the left, the electronic device 1 displays the object 81b as the first image for adjusting brightness in an area on the left side (area near the left end of a display area 22a in FIG. 8) within divided areas in the display area 22a of the first display part 20a. When the user's gaze moves to the right, the electronic device 1 displays the object 81c as the second image for adjusting volume in an area on the right side (area near the right end of a second display area 22b in FIG. 8) within divided areas in the display area 22b of the second display part 20b. By having such a configuration, the electronic device 1 can display the objects on the left and right outside in the view of the user, thus reducing the obstruction of the view.

The electronic device 1 according to the present invention may be configured so that a first operation part 30a provided near the left side of the head receives an operation related to the first image (object 81b) displayed in the left-side display part 20a and a second operation part 30b provided near the right side of the head receives an operation related to the second image (object 81c) displayed in the right-side display part 20b. By having such a configuration, the electronic device 1 is configured that the user can perform an operation on the operation part near the left side of the head (in many cases, it can be operated with a left hand), for example, when the user moves the gaze to the left, i.e., when the user gazes at the left side of the screen. Therefore, the input operation combining the eye movement with the movement of his/her hand is not troublesome, thus the convenience is improved.

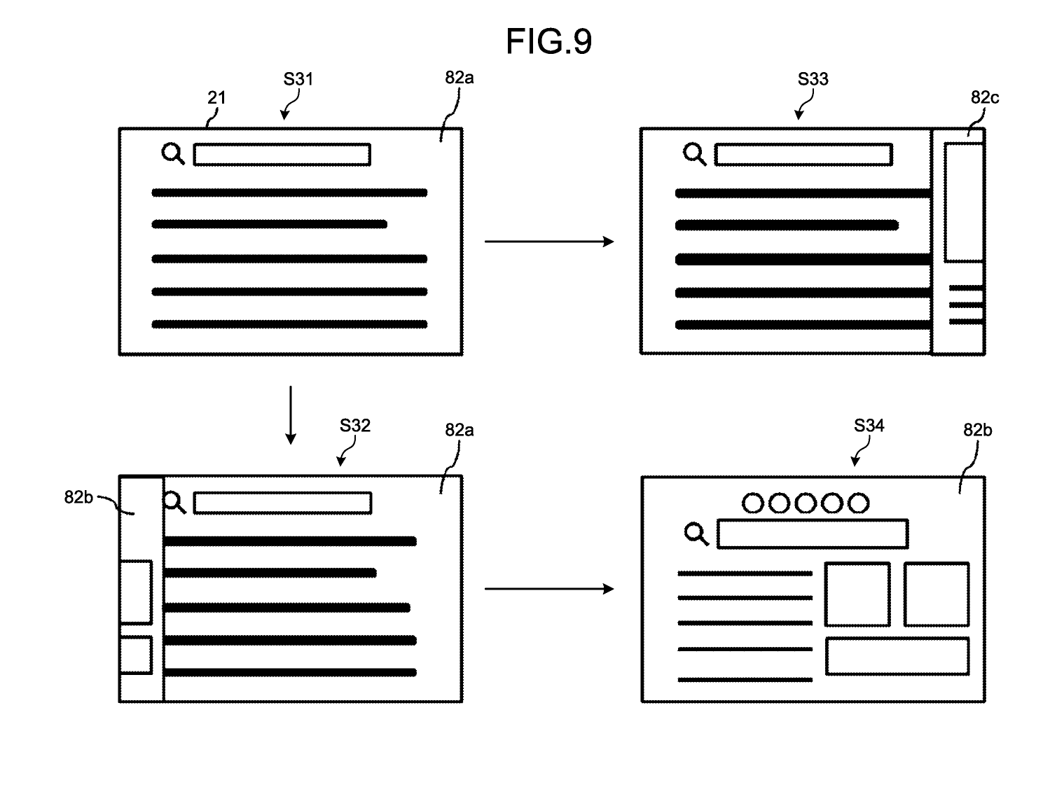

A fourth example in the display mode of the display 20 in the electronic device 1 will be explained next with reference to FIG. 9. FIG. 9 is a diagram illustrating the fourth example of the display mode of the display 20 in the electronic device 1. In the fourth example, the electronic device 1 is executing a browser application. At this time, the electronic device 1 can display one page among a plurality of web pages by making a transition between the web pages. For example, as illustrated at Step S31 of FIG. 9, the electronic device 1 displays a page 82a as the one page among the web pages in the display area 21 of the display 20.

When the detector 40 detects that the user's gaze moves to the left, the electronic device 1 displays a first image (page 82b) different from the page 82a in an area near the left end portion in the display area 21 as illustrated at Step S32 of FIG. 9. At this time, the page 82b is displayed and partially superimposed on the page 82a. Moreover, part of or whole of the display contents of the page 82b is displayed as the first image. Therefore, the user can check the display contents of the page 82b which is different from the page 82a while visually recognizing the page 82a in most of the display area 21.

When the detector 40 detects that the user's gaze moves to the right in a state in which the display state of the display 20 is as illustrated at Step S31 of FIG. 9, the electronic device 1 displays the second image (page 82c) different from the page 82a in an area near the right end portion of the display area 21, as illustrated at Step S33 of FIG. 9.

For example, the page 82b at Step S32 of FIG. 9 can be a web page previous to the page 82a, and the page 82c at Step S33 of FIG. 9 can be a web page next to the page 82a.

For example, when the detector 40 detects a predetermined user's eye movement in a state in which the first image (part or whole of the page 82b) is displayed as illustrated at Step S32 of FIG. 9, the electronic device 1 may change a display to the page 82b (other page) as illustrated at Step S34 of FIG. 9. In other words, the electronic device 1 changes the display state from the state in which the page 82a is displayed in most of the display area 21 to the state in which the page 82b is displayed in most of the display area 21. Moreover, for example, when the detector 40 detects a predetermined user's eye movement in a state in which the second image (part or whole of the page 82c) is displayed as illustrated at Step S33 of FIG. 9, the electronic device 1 may change the display to the page 82c (other page). In other words, the electronic device 1 changes the display state from the state in which the page 82a is displayed in most of the display area 21 to the state in which the page 82c is displayed in most of the display area 21. The predetermined user's eye movement may be, for example, the action of “multiple blinks” which is Pattern 4 of FIG. 5. By having such a configuration, the electronic device 1 allows the user to change the display to the display of any other page with a simple operation when it is desired while checking the other page.

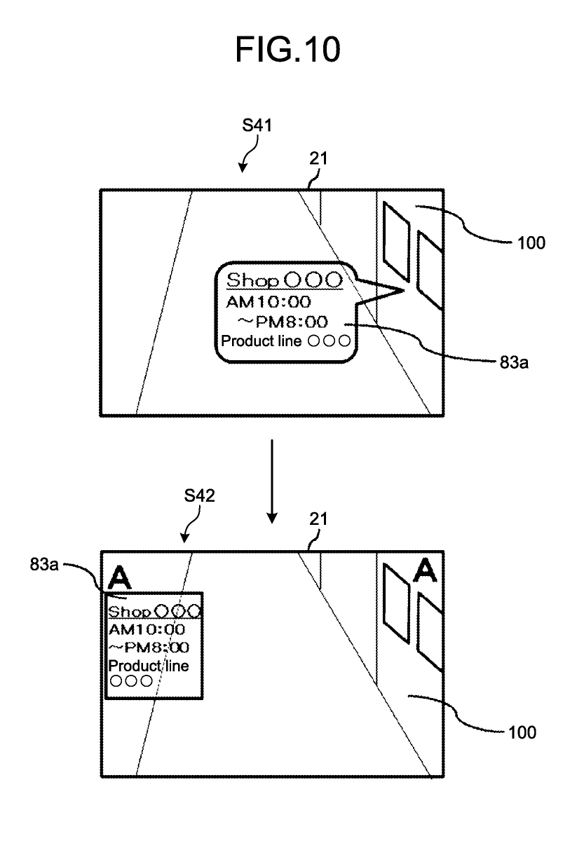

A fifth example in the display mode of the display 20 in the electronic device 1 will be explained next with reference to FIG. 10. FIG. 10 is a diagram illustrating the fifth example of the display mode of the display 20 in the electronic device 1. In the fifth example, the user visually recognizes a predetermined object through the display 20, and a predetermined image including information related to the object appears in the display 20. For example, as illustrated at Step S41 of FIG. 10, the user is walking in the town and is viewing a building 100 through the display 20. The electronic device 1 displays the information related to the building 100 in the form of speech bubble (object 83a) in the display area 21 of the display 20.

At Step S41, when the detector 40 detects that the user's gaze moves to the left, the object 83a displayed in the form of speech bubble is moved to an area near the left end portion in the display area 21 of the display 20 and is displayed therein as illustrated at Step S42 of FIG. 10.

As explained above, the electronic device 1 according to the present invention has a configuration in which when the user's gaze moves to the second area in a state in which a predetermined image is displayed in the first area within the divided areas in the display area of the display 20 (in the state of being displayed in the form of speech bubble at Step S41 of FIG. 10) or when the gaze moves from the first area to the second area, the predetermined image (object 83a) is moved from the first area to the second area and is displayed therein. By having such a configuration, the electronic device 1 can move the information unnecessary for the user or the information obstructing the view to a user's desired display area by simply moving the eyes, and therefore this is no more bothersome to the user.

As illustrated at Step S42 of FIG. 10, when the object 83a (predetermined image) is moved to the area (second area) near the left end portion of the display area 21 and is displayed therein, the electronic device 1 according to the present invention may display a message that the object 83a is associated with the building 100. For example, in the electronic device 1, as illustrated at Step S42 of FIG. 10, the alphabet “A” is displayed near the area where the object 83a is displayed and in the position where the building 100 is superimposed on the display area 21. By having such a configuration, even if information related to the building 100 is displayed in an area apart from the area where the building 100 is visually recognized, through the user's gaze movement, the electronic device 1 allows the user to easily recognize that the building 100 and the information are associated with each other.

In the electronic device 1 according to the present invention, when the detector 40 detects that the user's gaze moves laterally within a predetermined time in a state in which the object 83a is displayed in the display area 21 of the display 20 as illustrated at Step S41 of FIG. 10, it may be configured so that the object 83a is moved to areas near the left and right end portions of the display area 21 of the display 20 and displayed therein or is not displayed any more. By having such a configuration, the electronic device 1 can move the object 83a (predetermined image) to an area where it does not block the user's view and display it therein with a simple gaze movement.

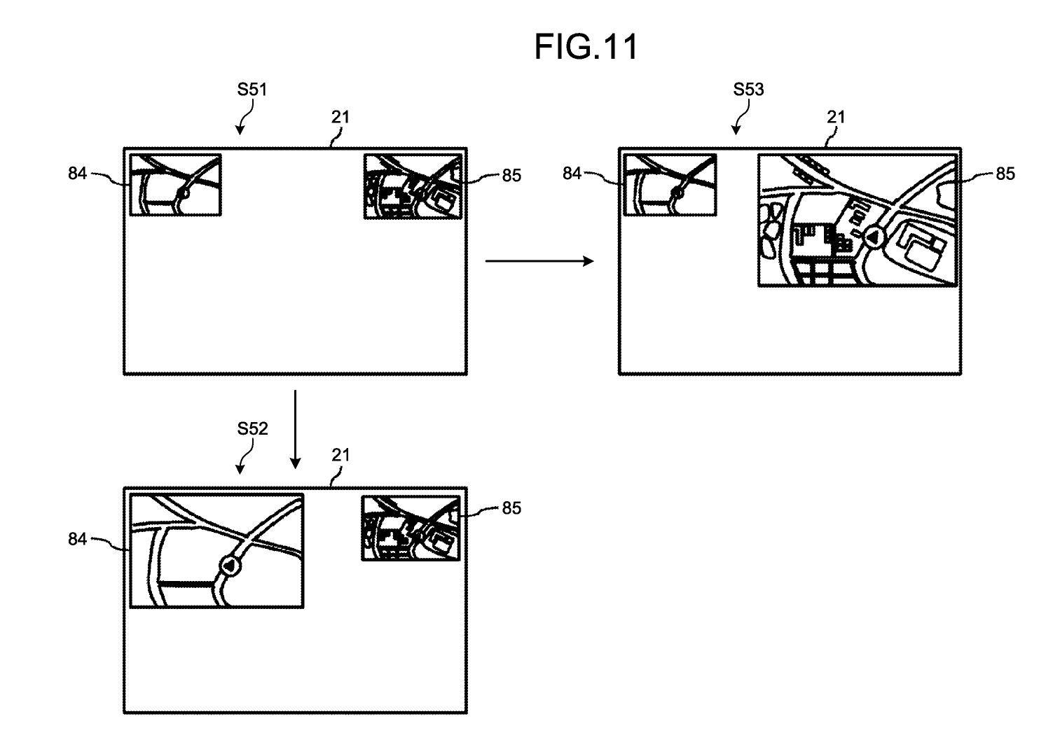

A sixth example in the display mode of the display 20 in the electronic device 1 will be explained next with reference to FIG. 11. FIG. 11 is a diagram illustrating the sixth example of the display mode of the display 20 in the electronic device 1. In the sixth example, a guide application is executed in the electronic device 1. As illustrated at Step S51 of FIG. 11, the electronic device 1 displays a map image 84 near a user's current location in an upper left area of the display area 21 of the display 20. Moreover, the electronic device 1 displays an aerial photograph 85 near the user's current location in an upper right area of the display area 21 of the display 20.

When the detector 40 detects that the user's gaze moves in an upper left direction in the state in which the display mode of the display area 21 is as illustrated at Step S51 of FIG. 11, the map image 84 is enlarged and displayed as illustrated at Step S52 of FIG. 11.

Meanwhile, when the detector 40 detects that the user's gaze moves in an upper right direction in the state in which the display mode of the display area 21 is as illustrated at Step S51 of FIG. 11, the aerial photograph 85 is enlarged and displayed as illustrated at Step S53 of FIG. 11.

Thus, the electronic device 1 according to the present invention has a configuration in which the first image is enlarged and displayed when the detector 40 detects that the user's gaze moves in a predetermined direction (first direction). By having such a configuration, the electronic device 1 can enlarge and display a user's desired image with a simple gaze movement, thus the convenience is improved.

When the map image 84 (first image) is enlarged and displayed as illustrated at Step S52 of FIG. 11, the electronic device 1 may be configured to reduce and display the map image 84 when the user's gaze moves in a direction different from the upper left direction (first direction) and to return the map image 84 to, for example, the state illustrated at Step S51 of FIG. 11.

When the map image 84 (first image) is enlarged and displayed as illustrated at Step S52 of FIG. 11, the electronic device 1 may be configured to enlarge and display the aerial photograph 85 (second image) and also reduce and display the map image 84 (first image) when the user's gaze moves in the upper right direction (second direction). By having such a configuration, the electronic device 1 reduces and displays the map image 84 at a timing at which the user shifts the eyes from the map image 84 to other display area, thus the convenience is improved.

In the example, the electronic device 1 is configured to enlarge and display the first image, which is triggered when the user's gaze moves in a predetermined direction, however, the configuration is not limited thereto. For example, when the detector 40 detects that the user's gaze position stays in the display area of the first image for a predetermined time or more, the electronic device 1 may enlarge and display the first image. When the user's gaze moves in a predetermined direction in the state in which the first image is enlarged and displayed, the electronic device 1 may determine that the user is about to view an indication different from the first image and reduce and display the first image.

According to the configuration, the user can recognize a destination while easily switching between the map image 84 and the aerial photograph 85 when the electronic device 1 is caused to execute the guide application.

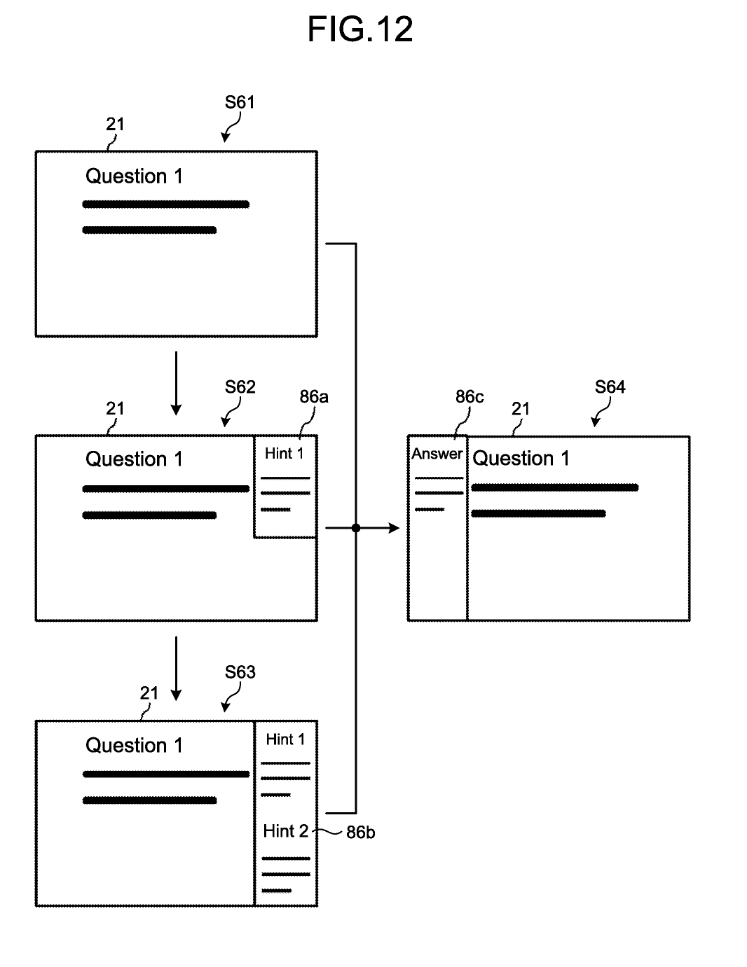

A seventh example in the display mode of the display 20 in the electronic device 1 will be explained next with reference to FIG. 12. FIG. 12 is a diagram illustrating the seventh example of the display mode of the display 20 in the electronic device 1. In the seventh example, a learning application is executed in the electronic device 1. As illustrated at Step S61 of FIG. 12, the electronic device 1 displays exam questions in the display area 21 of the display 20.

When the detector 40 detects that the user's gaze moves to the right, the electronic device 1 displays, for example, a hint 1 (first information 86a) related to a method for solving a problem in the display 20 as illustrated at Step S62 of FIG. 12. The hint 1 is displayed in an area near the right end portion of the display area 21. Therefore, the user can solve the problem with reference to the displayed hint 1.

When detecting that the user's gaze again moves to the right after the hint 1 is displayed on the display 20, the electronic device 1 displays other hint 2 related to the hint 1 (or detailed hint 2 for the hint 1) (second information 86b) as illustrated at Step S63 of FIG. 12. Therefore, the user can solve the problem with reference to the hint 2 when only the hint 1 is not enough to solve it.

For example, when the detector 40 detects that the user's gaze moves to the left in the state illustrated at any one of Steps S61, S62, and S63 of FIG. 12, the electronic device 1 may display an answer 86c to the question in the display 20 as illustrated at Step S64 of FIG. 12. The answer is displayed in an area near the left end portion of the display area 21. When the detector 40 detects a predetermined user's eye movement in the state in which the user's gaze stays in the display area where the answer is displayed, the electronic device 1 may display details of the solution of the problem (commentary contents) in the display 20.

As explained above, according to the present invention, it is possible to provide the electronic device provided with a new input mode that allows further improvement of the operability upon input.

Although the present invention has been explained with reference to the accompanying drawings and the embodiments, it should be noted that those skilled in the art can easily make various modifications and amendments based on the present application. Accordingly, these modifications and amendments should be included in the scope of the present invention. Moreover, all the technical matters disclosed in the present application are relocatable so as not to conflict, and it is also possible to combine a plurality of components into one unit or to divide the components into units.

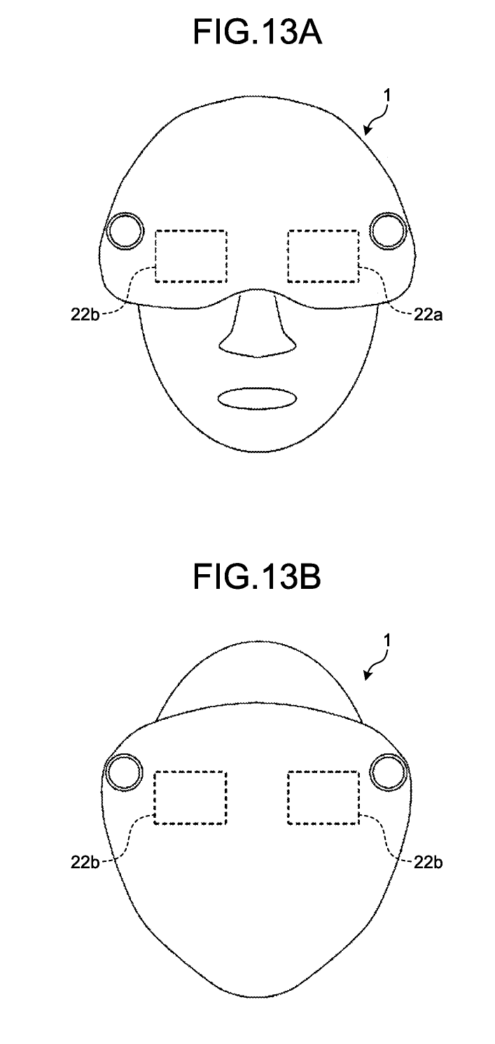

In the embodiments, the example in which the electronic device 1 has the form of eyeglasses (form of goggles) has been represented, however, the form of the electronic device 1 is not limited thereto. FIG. 13A and FIG. 13B are diagrams illustrating another form of the electronic device 1. For example, as illustrated in FIG. 13A, the electronic device 1 may have the form of a helmet type that covers substantially the upper half of the user's head. Alternatively, the electronic device 1 may have the form of a mask type that covers substantially the whole of the user's face.

In the embodiments, the configuration in which the display 20 has the pair of display parts 20a and 20b provided in front of the user's right and left eyes is exemplified, however, the embodiments are not limited thereto. It may be configured that the display 20 has one display part provided in front of either one of the user's right and left eyes.

In the embodiments, the configuration in which the marginal parts of the front part enclose the entire periphery of the edge of the display area of the display 20 has been exemplified. However, the embodiments are not limited thereto, and it may be configured so that the marginal part surrounds only part of the edge of the display area in the display 20.

1. An electronic device comprising:
a display; and
a detector configured to detect a user's gaze movement, wherein, when the detector detects that the user's gaze moves in a predetermined direction,
a first image is configured to be displayed in the predetermined direction side in a display area of the display.

2. The electronic device according to claim 1, wherein
the first image is configured to be displayed near a point where an outer part of the display area and a movement direction of the gaze intersect in the display area of the display.

3. The electronic device according to claim 1, wherein the predetermined direction is a direction same as a line connecting a point where the gaze movement is started with a point where the gaze movement is ended.

4. The electronic device according to claim 1, wherein the first image is configured to be displayed so as to enter inside of the display area of the display from outside thereof.

5. The electronic device according to claim 1, wherein the first image is configured to be displayed when the gaze moves in a first direction, and a second image is configured to be displayed when the gaze moves in a second direction.

6. The electronic device according to claim 1, wherein,
the first image is configured to be displayed, when the user's gaze moves to the left, in an area on a left side within a plurality of divided areas in the display area of the display, and
the second image is configured to be displayed, when the user's gaze moves to the right, in an area on a right side within the divided areas in the display area of the display.

7. The electronic device according to claim 1, wherein
the display includes:
a first display part provided in front of a user's left eye when the electronic device is worn by the user; and
a second display part provided in front of a user's right eye when the electronic device is worn by the user, wherein
the first image is configured to be displayed, when the user's gaze moves to the left, in the area on the left side within the divided areas in the display area of the first display part, and
the second image is configured to be displayed, when the user's gaze moves to the right, in the area on the right side within the divided areas in the display area of the second display part.

8. The electronic device according to claim 5, further comprising:
an operation part configured to include a first operation part provided near a left side of a user's head and a second operation part provided near a right side of the head and to receive an operation from the user when the electronic device is worn by the user, wherein
the first operation part is configured to receive an operation related to the first image, and
the second operation part is configured to receive an operation related to the second image.

9. The electronic device according to claim 8, further comprising:
a first side part configured to be supported by a user's left ear when the electronic device is worn by the user; and
a second side part configured to be supported by a user's right ear when the electronic device is worn by the user, wherein
the first operation part is configured to be provided on the first side part, and
the second operation part is configured to be provided on the second side part.

10. The electronic device according to claim 8, wherein
an object capable of adjusting a parameter associated with execution contents of a predetermined application is included in the first image or in the second image, and
the parameter is configured to be adjusted by a predetermined operation for the operation part.

11. The electronic device according to claim 6, wherein
a third image is configured to be displayed, when the user's gaze moves downward, in an area on a lower side within the divided areas in the display area of the display, and
a fourth image is configured to be displayed, when the user's gaze moves upward, in an area on an upper side within the divided areas in the display area of the display.

12. An electronic device comprising:
a display; and
a detector configured to detect a user's gaze position in the display, wherein, when the gaze moves from a first area to a second area within a plurality of divided areas in a display area of the display,
a first image is configured to be displayed in the second area.

13. The electronic device according to claim 12, wherein, when the gaze moves from the first area to the second area on the left side of the first area within the areas,
the first image is configured to be displayed in the second area, and
when the gaze moves from the first area to a third area on the right side of the first area within the areas,
a second image is configured to be displayed in the second area.

14. The electronic device according to claim 13, further comprising:
an operation part configured to receive an operation from a user, wherein
an object capable of adjusting a parameter associated with execution contents of a predetermined application is included in the first image or in the second image, and
the parameter is configured to be adjusted by a predetermined operation for the operation part.

15. An electronic device comprising:
a display; and
a detector configured to detect a user's gaze position in the display, wherein, when the detector detects that the gaze continuously stays in a first area within a plurality of divided areas in a display area of the display for a predetermined time or more,
a first image is configured to be displayed in the first area.

16. The electronic device according to claim 15, wherein,
when the detector detects that the gaze continuously stays in the first area on the left side within the areas for a predetermined time or more,
the first image is configured to be displayed in the first area, and
when the detector detects that the gaze continuously stays in a second area on the right side within the areas for a predetermined time or more,
a second image is configured to be displayed in the second area.

17. The electronic device according to claim 16, further comprising:
an operation part configured to receive an operation from the user, wherein
an object capable of adjusting a parameter associated with execution contents of a predetermined application is included in the first image or in the second image, and
the parameter is configured to be adjusted by a predetermined operation for the operation part.
